(19) United States
(12) Patent Application Publication
(10) Pub. No.: US 2017/0035083 A1
(43) Pub. Date: Feb. 9, 2017

(54) CORN BASED FOOD COMPOSITION

(71) Applicant: GREENFIELD SPECIALTY ALCOHOLS INC., Toronto (CA)

(72) Inventors: Mark Isaac SCHWARTZ, Woodbridge (CA); Andrew STEWART, London (CA)

(21) Appl. No.: 15/303,980

(22) PCT Filed: Nov. 10, 2014
(86) PCT No.: PCT/CA2014/000801

§ 371 Date: Oct. 13, 2016

Related U.S. Application Data
(60) Provisional application No. 61/979,196, filed on Apr. 14, 2014.

(51) Int. Cl. A23L 7/152; A21D 2/16; A21D 2/38; A23L 33/12; A23G 3/34; A23L 25/10; A23L 33/15; A23L 33/16; A21D 2/02; A23D 7/00

(52) U.S. Cl. CPC A23L 7/152; A21D 2/02; A21D 2/165; A21D 2/38; A23D 7/001; A23G 3/346; A23L 25/10; A23L 33/15; A23L 33/16; A23L 33/12; A23V 2002/00

(57) ABSTRACT

A food composition comprising pulverized corn germ and a fat source is described herein. The germ is derived from an isolated germ source that has not been derived from a wet milling process or extracted with organic solvent. The composition may have a paste form, which may be spreadable or flowable. The composition may include a vitamin and/or a mineral supplement, preferably from natural sources. Colorings and flavorings may be added. Cocoa may be added. The composition can be used in place of peanut butter or other spreads made with priority allergens, and thus can be used in institutional settings that have banned peanut and tree nut products. Methods of formulating the composition, as well as uses therefor, such as in confectionery, are described. The composition may be associated with health benefits.

### CROSS REFERENCE TO RELATED APPLICATIONS

This application claims the benefit of priority of U.S. Provisional Patent Application No. 61/979,196 filed Apr. 14, 2014, which is hereby incorporated by reference.

### FIELD

The present disclosure relates to a food composition based on corn germ.

### BACKGROUND

Spreadable food products are popular among children and adults alike. Nut-based food compositions, such as peanut butter, are ubiquitous in grocery stores. Many varieties and brands of peanut butter and tree nut butters (for example, cashew and almond butter) can be found in grocery stores as well as in specialty stores such as health food stores.

Some spreadable compositions have been described in the patent literature. U.S. Pat. No. 6,063,430, issued May 16, 2000 and entitled “Blended nut spread compositions and method of making” describes a nut-based spread with a relatively low viscosity that is formulated to avoid an oily appearance or a greasy mouth feel. U.S. Pat. No. 7,235,277, issued Jun. 26, 2007 and entitled “Nut butter and related products and method of making same” describes a nut-based spread prepared by mixing nut solids together with other ingredients in a special mill to achieve desirable textural properties.

Nuts such as tree nuts, and legumes such as peanut and soy, are popular choices for spreadable food products, and particularly for sandwich fillings. The high protein and fat content of nuts and legumes, and relatively low digestible carbohydrate (starch/sugar) content of nuts and legume make the spreadable “butters” formed therefrom into a complementary choice for pairing with bread or other grain-based substrates such as crackers. The complementary aspects of such a classic pairing as a peanut butter sandwich reflects not only the synergy of tastes, consistency, and mouth-feel, but is also a wise pairing from a nutritional stand-point, all of which can have a positive impact on the satiety of the consumer. For example the balanced effect of the starch component (primarily derived from the bread) with the fat and protein content (primarily derived from the peanut butter) to achieve a desirable calorie ratio of carbohydrate to fat to protein or (CHO:Fat:Pro) that approximates an exemplary overall dietary calorie ratio of 55:30:15, consistent with recommendations for healthy growing children set by Health Canada. A sandwich with 2 pieces of bread (a CHO:Fat:Pro calorie ratio of 69:19:20, in a total of 200 calories) and one tablespoon of peanut butter (containing just nuts and having a calorie ratio of 13:73:14 in a total of 100 calories), results in a sandwich having a desirable overall ratio of 50:37:13.

Different protein sources contain different ratios of amino acids. Health Canada recommends that the indispensible amino acids be present at least in the amounts shown in Table 1. These levels may be used for comparison when evaluating the nutritional completeness of a protein. Sometimes referred to as “essential amino acids”, these indispensible amino acids cannot be synthesized within the human body from other amino acids (or de novo), and thus must be derived from dietary protein sources.

TABLE 1
Recommended Levels of Indispensible
Amino Acids In High Quality Protein¹

| Amino Acid(s) | Quantity (mg/g protein) |
|---|---|
| Histidine | 18 |
| Isoleucine | 25 |
| Leucine | 55 |
| Lysine | 51 |
| Methionine + Cysteine | 25 |
| Phenylalanine + Tyrosine | 47 |
| Threonine | 27 |
| Tryptophan | 7 |
| Valine | 32 |

¹Reference ammo acid pattern recommended by Health Canada for evaluating the quality of food proteins using the protein digestibility corrected amino acid score (PDCAAS). Based on estimated average requirements for both indispensable amino acids and for total protein for 1-3 year olds (http://www.hc-sc.gc.ca).

While animal-derived protein sources generally approximate the recommended indispensible amino acid levels more closely than do plant-derived sources, combinations of plant-derived protein sources can be utilized to more closely approximate these desirable ratios, thereby increase the quality of the protein when consumed in combination. The concept of complementary protein sources is of assistance for vegetarian, and in particular vegan, meal planning.

Increased awareness and increased reported incidence of nut allergies in recent years has resulted in the banning of peanut and tree nut products from schools, child care facilities, institutions such as hospitals, and other public places frequented by the public, and by children, in particular. Such spreads can be sticky and difficult to clean from surfaces such as school desks and lunchroom tables. While the trend to ban peanuts and tree nut products has resulted in a safer school environment for children with relevant allergies, it has narrowed the available choices of sandwich fillings for school day lunches, especially for vegetarians.

Substitute spreads, emulating the appearance and/or consistency of peanut butter, are available based on legumes or other proteinaceous substances. Examples of this include spreads made from soy beans and sunflower seeds. Such substitute spreads may be visually indistinguishable from nut butter. While such similarities may increase the consumer acceptance of such a product as a peanut butter replacement, the similarities in color and consistency may contribute to the confusion over the content of a child's sandwich in an environment where nuts are not permitted. While allergic reactions are complex physiological phenomena, it its clear that peanut and tree nut proteins are one of the most common allergens associated with severe anaphylactic allergic reactions.

Corn (or maize) is an important crop world-wide. Corn may be grown primarily for human consumption in economically challenged regions of the world. However in economically developed western nations such as in Canada and the United States, corn is grown not only for human consumption for also for animal feed and industrial use. When corn is used in industrial applications, the carbohydrate and/or fat content is most highly utilized, for example the carbohydrate content may be fermented to produce ethanol. In such processes, corn germ, which is higher in fat and protein compared with whole corn, may be parsed as a by-product.

Corn is not a common allergen. Health Canada has categorized the following as priority allergens for food product labeling purposes: peanut, egg, milk, tree nut, wheat, soy, sesame seeds, seafood, sulphites and mustard. Ingredients outside of these priority allergens are much less likely to be common allergens, and are thus of less concern for causing reactions in environments where children are present over meal times, such as in a school. Although as an alternative to peanuts and tree nuts, soybeans can be processed to create a substance similar to peanut butter in both crunchy and smooth consistencies, it is nevertheless noteworthy that soy is, itself, a priority allergen recognized by Health Canada.

There is a need for a nutritious spreadable sandwich filling that does not contain peanuts or tree nuts.

### SUMMARY

It is an object of the present disclosure to provide a spreadable food composition that does not contain peanuts or tree nuts.

There is described herein a food composition having a paste form, comprising pulverized corn germ and a fat source.

There is also described herein a food composition having a paste form for use as a peanut or tree nut butter replacement, the composition comprising pulverized corn germ and a fat source.

Further, there is described herein a method of preparation of a food composition comprising: obtaining pulverized corn germ from an isolated corn germ source; and mixing the pulverized corn germ with a fat source to form a paste.

Further uses and methods of use for the food composition are described herein, for example in a confectionery.

Other aspects and features of the present disclosure will become apparent to those ordinarily skilled in the art upon review of the following description of specific embodiments in conjunction with the accompanying figure.

### BRIEF DESCRIPTION OF THE DRAWING

Embodiments of the present disclosure will now be described, by way of example only, with reference to the attached Figure.

FIG. 1 is a depiction of the typical nutritional specifications of a corn germ product, such as GreenField Naturals VitaGerm™, stated per 100 g of product.

### DETAILED DESCRIPTION

Generally, the present disclosure provides a composition that is spreadable and can serve as a sandwich filling replacement, for example in lieu of peanut butter. The composition is described in the context of its preparation, benefits, and exemplary forms.

As used herein, the term “priority allergens” refers to food ingredients recognized as potential allergens for which special labeling requirements may be required. Priority allergens include peanut, egg, milk, tree nut, wheat, soy, sesame seeds, seafood, sulphites and mustard.

As used herein, the terms “cocoa” and “cocao” may be used interchangeably to refer to a raw or processed product derived from the botanical source (tree) that chocolate comes from: Theobroma Cacao. Suppliers may provide the products of Theobroma Cacao as cocoa, cocao, or chocolate. Terminology used herein attempts to align ingredients with the product or ingredient name which may be provided, listed, or utilized by a supplier.

A food composition is described herein, which has a paste form. The composition comprises pulverized corn germ and a fat source. The corn germ may be pulverized from an isolated source, which may optionally be an intact corn germ source, such as an intact corn germ source which has not been exposed to or extracted with organic solvent. Broken corn germ sources may also be used.

The composition may additionally comprising sugar, salt, mono-glyceride, di-glyceride, or a mixture of these.

The total fat content of the composition may fall within the exemplary range of from 20 to 65% fat by weight. For example, the composition may have from 30 to 55% fat by weight. A specific example of the total fat content of the composition may be about 45% by weight.

The corn germ used in the composition is pulverized, and typically achieves a smooth consistency. The pulverization may lead to an average particle size of from 0.1 mm to 4 mm (0.004 inch to 0.016 inch).

A vitamin supplement, mineral supplement, or a combined vitamin and mineral supplement may be added to the composition. For example, the supplement chosen may be one which augments the vitamin or mineral content of the composition to the extent that at least one vitamin or mineral can be categorized as an “excellent source” or a “good source” according to Health Canada labeling requirements. Optionally, the supplement used may be one that is derived from a natural or organic source.

A dietary fibre or an indigestible edible component that is fermentable by colonic bacteria may also be added to the composition.

The fat source used in the composition may be selected according to a variety of properties, either by taste preference, oil composition, consistency, or availability. A plant source oil that is high in omega-3 fatty acids may be used as the fat source or as a component thereof. Further, the fat source may comprise a plant source that is high in saturated fats. Exemplary fats include coconut and palm sources, which have the advantage of achieving a solid consistency at higher temperatures (such as ambient room temperature), which may assist in formulating a desired consistency of product. The fat source may comprise a plant source that has been hydrogenated. Canola oil or camelina oil are exemplary oils high in omega-3 fatty acids. Blended fats and oils may provide the fat source for the composition, as this would permit a formulation to be tailored to the characteristics desired by the target consumer of the product.

The composition may additionally comprise a flavor or a color. For example, a color may be added to change the composition to a different color (than the uncolored composition) that is visually distinguishable from the color of peanut butter. Alternatively, the color may be added to change the composition to more closely resemble that of peanut butter, depending on the consumer preferences.

Cocoa and/or chocolate may be added to the composition if desired.

The composition may possess an indispensable amino acid content that meets or exceeds the recommended levels of indispensable amino acids (sometimes referred to as “essential amino acids” for the body's inability to synthesize these amino acids) as set by Health Canada for high quality protein.

The composition is in the form of a paste, but the consistency of the paste may be more or less malleable or runny. For example, the composition in paste form may have a spreadable consistency, such as a “butter” or a flowable consistency as a ribbon or thick syrup which may be referred to herein as a variegate consistency. The consistency may change to be more or less viscous or flowable at different temperatures, and generally the paste becomes less malleable at colder temperatures, and more spreadable or flowable when heated. Colder (refrigeration or freezer) temperatures may render the paste harder and less spreadable, but it is nevertheless still considered to be a “paste”. Warmer temperatures (ambient room temperature or warmer/heated temperatures) may render the paste softer or even runny, but it is nevertheless considered to be a “paste” or as having a “paste form”, as described herein.

There is described herein a food composition having a paste form for use as a peanut or tree nut butter replacement, the composition comprising pulverized corn germ and a fat source.

The composition described herein may be used for bestowing nutritional or health benefits to an individual. The individual may be a growing child. The individual may be one who has an allergy or is suspected of having an allergy to a priority allergen, in which case the nutritional or health benefit bestowed may extend beyond simply providing a good source of protein, as it is safer to the individual to utilize a non-allergenic food source as a prophylactic measure in avoiding allergic reactions. Such allergic reactions can be anaphylactic and thus, life-threatening.

Individuals who may benefit nutritionally or from a health standpoint from consuming the product include those who are immune-compromised, those who are diabetic or pre-diabetic, individuals who may experience joint pain, individuals having high cholesterol or blood lipids, or individuals having or at risk of developing cardiovascular disease. Oral consumption is the preferred route. Individuals unable to chew food or who may be intubated due to an ability to swallow may receive the composition in a manner consistent with enteral delivery of blended mixtures of foods. Such individuals may for example, be growing children.

A method of bestowing nutritional or health benefits to an individual who orally consumes the composition may be a person who has an allergy or is suspected of having an allergy to a priority allergen. Further, the person may be in a category of individuals who are not particularly identified as having an allergy, but who may be of an age group or other general classification for which consumption of a priority allergen is unadvisable or viewed as a potential trigger to the later development of an allergy. For example, the individual may be immune-compromised, diabetic or pre-diabetic, may have joint pain, may have high cholesterol or blood lipids, may have cardiovascular disease, or may be considered too young to consume a priority allergen.

There is described herein a method of preparation of a food composition comprising obtaining pulverized corn germ from an isolated, optionally intact, corn germ source; and mixing the pulverized corn germ with a fat source to form a paste. Optionally, prior to mixing, the corn germ may be pulverized to a smooth consistency.

In this method, the pulverized corn germ may attain an average particle size of from 0.1 mm to 4 mm (0.004 inch to 0.016 inch). For example, the pulverized corn germ may have a particle size of from 0.12 mm to 2.0 mm (0.005 inch to 0.007 inch). A specific exemplary size may be about 1.5 mm (0.006 inch). In an exemplary embodiment of this method, the corn germ source is not isolated by wet milling, and/or may not have been exposed to an organic solvent. While average exemplary particle sizes are noted here, it is possible to achieve other consistencies using larger or smaller particle sizes, which would nevertheless be considered as pulverized germ. When particle size is intended to be toward the smaller size, then optionally, more oil may be added to achieve the smaller and smoother consistency. Larger and smaller particle sized can be readily distributed within the exemplary average ranges provided herein. For example, when an average particle size is 0.006 inch, it is possible that larger particles of 0.0155 inch may be present in the composition. Further, chunks of unground germ may be added to achieve a crunchy consistency of product.

In this method, additional ingredients may be added such as sugar, salt, mono-glyceride, di-glyceride, or a mixture thereof, and these may be added to the corn germ during or after mixing the corn germ with the fat source.

Further, in this method, a vitamin supplement, a mineral supplement, or a combined vitamin and mineral supplement may be added during or after mixing the corn germ with the fat source.

The method may also involve adding a dietary fibre or an indigestible edible component that is fermentable by colonic bacteria, either during or after mixing the corn germ with the fat source.

The fat source added in this method may comprise a plant source oil high in omega-3 fatty acids, such as the exemplary oils: canola oil or camelina oil, or mixtures of these. Further, the fat source may comprise a plant source that is high in saturated fats, and/or a plant fat source that has been hydrogenated, for example partially hydrogenated.

Optionally, in this method a flavor or color may be added during or after mixing the corn germ with the fat source. For example, if color is to be added, it may be desirable that the color is added to change the composition to a color that is visually distinguishable from the color of peanut butter. Natural sources of color and flavor may be selected.

In certain embodiments of the method, cocoa or chocolate may be added during or after mixing the corn germ with the fat source.

In the method described, the composition may be formulated to have a spreadable consistency or a flowable consistency.

A confectionery comprising the composition may be prepared, and may have the taste, appearance, sweetness, and additional ingredients desirable to the intended use or application. Further, the confectionery may be shaped according to the desired style of confectionery, such as in the shape of a sphere, drop, chip, nugget, bar, square, butter cup or topping.

Corn Germ Composition. Corn germ is a healthy source of protein. The differences in the composition of the main parts of a kernel of corn can be characterized as follows. The main components of a corn kernel, once the seed coat is removed, are endosperm and germ, with the endosperm accounting for the majority of the kernel.

The outer portion (seed-coat or pericarp) of a kernel of corn is characterized by a high crude fibre content of about 85 percent or greater by weight. The fibre composition is primarily hemicellulose and cellulose, with a small amount of lignin. These fibres are valuable to human nutrition as roughage (particularly for colon health) and for slowing absorption of digestible carbohydrates when whole corn is consumed, but they are indigestible carbohydrates that do not contribute substantially to the energy (calorie composition) of corn.

The endosperm of a kernel of corn is the starch storage portion of corn, and contains a high level of complex carbohydrate in the form of starch (about 90%), the remainder being primarily protein. Fat content in the endosperm is relatively low.

The germ portion of a kernel of corn is characterized by a crude fat content, that may range from 20 to 30 percent by weight, depending on the variety. The germ also contains a relatively high level of protein (about 20 percent by weight) as well as minerals, fibre, water and some sugar.

Where corn flour is used as a staple food product, the degermed grain is typically used, and the protein content is derived almost exclusively from the endosperm protein. When processed whole corn is used, both the germ and the endosperm are contributors to the protein content, and thus to the amino acid composition. The amino acid content of germ proteins is quite different from that of endosperm protein.

Table 2 provides a typical analysis of the indispensible amino acids in corn from the endosperm and germ portions (expressed as mg/g protein), and provides a comparison with the recommended levels of indispensible amino acids present in a high quality protein.

TABLE 2
Comparison of Indispensible Amino Acid Levels in Proteinaceous
Corn Components with Levels In High Quality Protein

| | | | High Quality |
|---|---|---|---|
| | Corn Endosperm¹ | Corn Germ² | Protein³ |
| Amino Acid(s) | (mg/g protein) | (mg/g) | (mg/g) |
| Histidine | n/a* | n/a* | 18 |
| Isoleucine | 36.5 | 57.8 | 25 |
| Leucine | 102.4 | 103 | 55 |
| Lysine | 22.8 | 79.1 | 51 |
| Methionine + Cysteine | 24.9 | 36.2 | 25 |
| Phenylalanine + Tyrosine | 84.2 | 82.6 | 47 |
| Threonine | 31.5 | 62.2 | 27 |
| Tryptophan | 4.8 | 14.4 | 7 |
| Valine | 40.3 | 78.9 | 32 |

^{1,2}Orr, M. L, and Watt, B. K., 1957, Amino Acid Content of Foods, Home Economics Research Report No. 4, Washington DC, USA. US. Dept. Agric. 88 pp., as cited by FAO, Food and Agriculture Organization of the United Nations (www.fao.org).
³Reference amino acid pattern recommended by Health Canada, as reported in Table 1 (http://www.hc-sc.gc.ca).
*Source not reporting histidine analysis.

Given that different corn varieties have different qualities, it has been estimated by the FAO that the endosperm represents between 70 and 86 percent of the kernel weight for whole corn, while the germ between 7 and 22 percent by weight, it can be seen that the germ protein more closely meets or exceeds the recommended levels of indispensible amino acids when compared with endosperm source protein. Then whole kernel corn is consumed, the balance of protein is weighted toward the endosperm protein, and the amino acid quality, while improved over endosperm protein alone, is nevertheless inferior in indispensible amino acid content when compared to consumption of germ alone.

The amino acid pattern in corn germ protein is higher and better balanced than corn endosperm protein. In endosperm protein (the protein component of corn flour), as well as in whole corn, the low content of lysine and tryptophan, relative to the recommendation limits the quality of the protein.

As can be seen in Table 2, the corn germ meets and exceeds the recommended indispensible amino acid levels in all reported categories, unlike the endosperm protein which is below the recommended levels for lysine and tryptophan. Utilizing corn germ can thus be seen to offer a higher quality of protein than whole corn, or protein derived from corn flour.

Isolation and Processing of Corn Germ. In some germ-removal processes, corn-germ derived protein may be isolated using a wet milling processes involving steeping in water and sulfur dioxide (SO₂), then separated, dried, and hexane extracted. During such a process, the germ may lose some food value and flavor, and may be undesirable as food grade germ.

An alternative process for isolation of corn germ is taught for example in U.S. Pat. No. 7,887,862 entitled “Method and apparatus for separating, purifying, promoting interaction and improving combustion”, to Industrias Centli S.A., describes a process for separating the endosperm, pericarp, and germ by placing corn kernels in a fluid medium while simultaneously inducing cavitation within the fluid and subjecting the corn kernels to centrifugal force to separate the kernel components. The process does not require the kernels to be crushed by milled by a degerminator before separation of the components, which permits the germ to be obtained intact. Another process is described in U.S. Pat. No. 7,452,425 entitled “Corn refining process”, and utilizes hot water to separate corn germ from other kernel components.

The exemplary processes used by Industrias Centli S.A., and other such processes which permit germ separation or removal in a manner that causes little degradation of the corn germ, while permitting full isolation of kernel components so that components can be parsed and utilized for different purposes, are desirable. Any such method of germ isolation may be utilized.

Processes other than wet milling, such as those of Industrias Centli S.A. which do not require an extraction with solvent to isolate germ, are preferred. Such processes may also be more economical and able to assure that nutrition and flavor qualities of the germ are maintained.

Germ isolation processes which use low heat levels to achieve a toasting effect may be used to bring out nutty flavors from the corn germ proteins. A typical native corn germ is a contained component of a kernel, resembling a nugget, having a size of about 3 mm, and composed of fine materials and fibres. This nugget may possess a crunchy consistency.

To transform the isolated corn germ into a paste or butter so as to achieve a spreadable consistency, the germ is ground or pulverized, optionally with an added oil, to a fine consistency. While the majority of the germ may be ground to a fine consistency as a homogeneous paste, some nuggets of germ may remained in a partially ground, or simply broken/crushed state so as to achieve a “crunchy” effect, as desired, within the main smooth paste. The effect may be similar to that of crunchy and smooth varieties of peanut butter. This allows the consumer to select from optional products according to preference.

Equipment which may be used to achieve the grinding and/or pulverization may include a mill-type grinder typically used in the peanut butter industry. Other types of grinders, such as rotating drum type, or pressure type mortar/pestle equipment may be used to achieve the desired consistency. A grinder, such as is available from Urschel Laboratories Inc. of Valparaiso Ind., USA, for example with a 180084 head, may be used.

The corn germ may be processed into thicker or thinner consistencies as appropriate for the composition to be prepared, whether a spreadable paste, a shaped semi-solid, such as a confectionary or component thereof (such as semi-solid chips for baking cookies or a filling for a cup-shaped product like Reeses™ Peanut Butter Cups), or for a flowable consistency such as is used in variegates or toppings for desserts and decorative finishes.

Spreadable Paste (or “Butter”). Once isolated, and optionally toasted before grinding, the germ (or toasted germ) is then ground and/or mixed with desired components which may add beneficial consistencies, organoleptic properties, or nutritional value. Such components are mixed with the germ either during grinding, or following the grinding, once the germ has reached the desired consistency. It is understood that temperature affects the consistency of such a paste or butter, and that at higher temperatures above ambient room temperature, a composition may soften from a hard or semi-solid paste consistency into a flowable paste consistency. Whether semi-solid or flowable, the term “paste” is used herein to describe the malleable nature of the composition whether spreadable or flowable.

Oil, sugar and salt are exemplary ingredients which may be to make a basic spreadable corn germ butter. Ingredients which may thickening and/or stabilize the butter may be added, which include fats or oils such as saturated fat and/or mono-glycerides or di-glycerides of saturated fatty acid residues or some combination of these.

Table 3 shows the typical composition of a spreadable corn germ butter composition.

TABLE 3
Typical Formula Components for Corn Germ Butter

| | % (weight basis) of typical |
|---|---|
| Component | range in composition |
| Toasted Corn Germ (of Moisture <6%) | 40-70% |
| Oil | 20-35% |
| Sugar | 5-15% |
| Mono-glyceride (optional) | 0-3.5% |

The composition may have the consistency of a flowable composition/paste or “variegate”. A flowable composition, such as a topping, may be formed of the corn germ, which may be prepared having a reduce viscosity so as to achieve not just a spreadable consistency, but a flowable consistency for us as a topping. A variegate may be a thinner sweeter variant of the butter, typically used as a topping or ribbon in or on top of ice cream or other desserts. Fillings for use in cup-shaped confectionery items may also be flowable at temperatures utilized in manufacture, while taking on a thicker (semi-solid or paste-like) consistency at ambient temperatures.

Such a flowable composition may be formed by using less germ with more oil or water and sugar so as to achieve a sweet flowable ice cream additive, ribbon or topping. The desired thickness to be achieved at various temperatures for different exemplary uses of the technology can be altered by varying the degree of saturation or saturated mono-glycerides addition with varying degrees of germ, or by utilizing sugar and water to achieve a desired efficiency.

Table 4 shows the typical composition of a spreadable corn germ butter composition.

TABLE 4
Typical Components in Corn Germ Variegate

| | % (weight basis) of typical |
|---|---|
| Component | range in composition |
| Toasted Corn Germ (of Moisture <6%) | 30-60% |
| Oil | 20-35% |
| Sugar | 15-35% |
| Mono glyceride (optional) | 0-3% |

In use. The spreadable paste may be used in any manner that peanut butter has previously been used. The spreadable paste can be mixed with additional icing sugar to make a topping/filling for cakes, muffins, cookies, butter cups, etc. These uses may be applied to foods that may have traditionally included a nut-based spread, but which requires modification because a peanut- tree nut-free product is desired. Peanut butter cookie recipes can be modified using the corn butter composition described herein in place of the peanut butter ingredient to a achieve a similar consistency and mouth-feel, but without risk of a nut-related allergic reaction. Further, a variety of baked products such as squares, bars, cookies, cupcakes, pies, tarts or cakes are encompassed herein.

The composition can be used as a filling for chocolates, cookies and cakes, or for other sorts of confectionary or candy. The composition may include optional ingredients, such as exemplary flavorings, colorings, texture-altering ingredients described herein. Natural product based ingredients advantageously add to the health benefits of the composition.

Ingredients. A fat source, such as oil, is added to the composition to achieve the desired consistency. Oils such as omega-3 containing oils from flax, canola, camelina and vegetable sources may be used. Coconut and palm oil, and other sources of monounsaturated fats may also be used. Blends of fats may be used to achieve a desirable composition of fatty acids, as determined by consumer preference. Levels of total fat content of the composition may range from 20 to 65% (on a weight/weight basis), for example from 30 to 55%, such as a total of about 35%, about 40% or about 50% fat by weight. This can include the fat content of the germ itself, together with the added fat or oil source. Higher fat levels may be used to produce softer or more flowable paste compositions. Optional ingredients may be added to the composition in order to increase consumer acceptance with respect to organoleptic properties, such as flavor saltiness or sweetness. A flavoring, sweetener, salt, or spices may be added as desired.

Ingredients may be added to the composition in order to bestow consistency or mouth-feel properties as desired. For example, chunks of unground or mildly ground corn germ may be added to achieve a crunchy effect. Desiccated fruits or vegetables may be added to the composition to achieve a desired consistency, and may have the added benefit of contributing to the nutrient content of the composition.

The color of corn germ differs from that of the typical peanut butter or nut butter, but only in a minor amount that may not be adequately distinguishable in a setting that may be deemed peanut-free or tree nut-free, such as in schools or daycares. Thus, although parents may assure teachers that the sandwich filling is not peanut butter, a distinct color contributed by an ingredient, and preferably a natural ingredient, could further distinguish the composition from such nut butters. The coloring contributed by green, red or or orange vegetables, which may be desiccated to a low water content, could render a composition that has a distinct orange or red hue, or which has been rendered darker than the light brown color expected of a nut butter, for example if a dark green vegetable is added to the composition. Benefits of adding coloring that may be contributed by such naturally occurring sources include rendering the spreadable version of the composition distinct from peanut butter and tree nut butter.

For flavoring and color, the addition of chocolate, vanilla, cocoa powder, and other flavorings may be used. Addition of chocolate or cocoa to achieve a chocolate flavor may be a particularly suitable ingredient for enhancing consumer acceptance. Compositions including cocoa powder have the natural advantage of including beneficial components such as flavonoids found in cocoa powder, while the control of the amount of sugar or sweetener can be exerted by the manufacturer according to the desired utility of a product. A sweetened version of a chocolate flavored composition (comprising cocoa powder) could be rendered similar to the Nutella™ product, but without the tree nut content, the product could be utilized in an allergen-free environment.

Optional ingredients that may be added to the composition are not limited. The composition may include oils or fats which have beneficial health properties. Such oils may be ones that are high in omega-3 fatty acids, such as canola oil or camelina oil.

The composition may include dietary fibres, either of a soluble/fermentable type, an insoluble/non-fermentable type, or of a mixed type from any origin. Indigestible edible components or carbohydrates which may pass through the small intestine unabsorbed in humans, but which may be fermented by colonic bacteria into short-chain fatty acids may also be included. Such ingredients may bestow beneficial health properties upon the composition.

Health Benefits. The compositions prepared as described herein can be formulated using all natural ingredients. For those looking to derive high quality protein from plant sources, while avoiding animal fat and cholesterol (associated with animal-derived fats), the corn germ based compositions described herein are a nutritious and delicious way of deriving calories from a source that is also low in carbohydrate. Other benefits such as avoidance of allergic reactions as described above, may be realized.

By utilizing products that are low in sugar and starch, as well as low in animal fats, heart health and blood sugar levels (pertaining to diabetic health), can be improved.

### EXAMPLES

### Example 1

NutraButter™ Composition

The following composition is prepared based on corn germ to produce an all-natural, food composition, for use in optimizing the health, for example the heart health, of a subject.

The base material providing the corn germ for the composition of this Example is the proposed product VitaGerm™ mix an all-natural dietary source of multiple nutrients. VitaGerm™ mix is a superior choice when compared to artificial and/or synthetic vitamin or nutrient supplements, as the form in which naturally derived nutrients are present leads to superior absorption. Corn germ is naturally high in good quality protein, dietary fibre and plant-source fat (which is thus cholesterol-free), and is relatively low in saturated fat. Corn germ is also very high in potassium and magnesium, and thus can serve as a good or excellent dietary source for such nutrients.

The proposed NutraButter™ composition including VitaGerm™ mix is considered non-allergenic in Canada and the US, meaning that no cautionary label wording need be utilized on packaging. This is a major advantage over peanut, tree nut and soy based spreads, all of which pertain to a priority allergen and require special labeling.

NutraButter™ composition is higher in dietary fibre, both insoluble and soluble forms, than competing spreads. Fibre is of benefit to digestive health (typically attributed to insoluble fibre) and heart health (typically attributed to soluble fibre).

NutraButter™ composition is high in many components considered to be “health boosting” for nutritionally conscious consumers. For example, minerals including magnesium, chromium, zinc and manganese which have been linked to diabetic support are found in high quantities in the composition.

NutraButter™ composition is low in sugar, with only 2 g per 32 g of product. With the high fibre content (which may be claimed as a “Good” or “High” source on the package label) combined with protein and lipid content, NutraButter™ composition should be low on the glycemic index. Below 55 on the glycemic index is considered “low” in Canada and the US. Thus, the composition is suitable for diabetics and pre-diabetics.

NutraButter™ composition contains naturally occurring phytosterols which are desirable to those consumers looking improve or support heart health. Combined with vitamins B6 and folic acid and fibre content, NutraButter™ composition provides nutrients which are viewed by a discerning consumer public to address risk factors for heart disease.

NutraButter™ composition is rich in omega-3 ALA (alpha-linolenic acid), attributable to the presence of canola oil in the formulation. Omega-3 fatty acids have been attributed with numerous health benefits, as would be known to a discerning consumer.

NutraButter™ composition is low in saturated fat and is free of trans fatty acids and cholesterol, which are all desirable qualities to a discerning consumer.

NutraButter™ composition in this example is also dairy free, which together with the lack of any other animal product in the composition renders it desirable and appropriate for both lacto-ovo vegetarian and vegan vegetarian consumers.

NutraButter™ composition contains naturally occurring lutein and zeaxanthin, which are considered to be beneficial nutrients for eye health. Further, NutraButter™ composition contains naturally occurring choline, a substance that has been shown to be linked to better brain health. The presence of such substances renders the composition particularly desirable to the aware and discerning consumer of health food products.

NutraButter™ composition is made from an all-natural source of corn germ that has been isolated without the use of organic solvents, and subsequently toasted and pulverized. The corn germ itself contains nutrients that individually have been shown to have benefit in cardiovascular health (such as fibre, vitamins and phytosterols) as well as diabetic health. The combination and levels of such nutrients as are found in NutraButter™ composition renders the product a prudent consumer choice as a non-allergenic spread.

The full compositional content for NutraButter™ composition, and comparison of the composition to commercially available sunflower butter, soy butter and peanut butter is provided in Table 5. This table shows relatively similar calorie and macronutrient content (carbohydrate, fat, and protein), but also demonstrates that higher content of certain nutrients such as vitamins and minerals are derived from the corn germ product, leading to an equally if not more nutritious composition than seed, nut or soy based proteinaceous spreads.

TABLE 5
NutraButter ™ Composition Nutritional Comparisons
With other Proteinaceous Spreads

| Component per | NutraButter ™ | | Sunflower | | Soy | | Peanut | |
|---|---|---|---|---|---|---|---|---|
| 32 g (2 tbsp) | Composition | | Butter | | Butter | | Butter | |
| Calories | 180 | | 200 | | 200 | | 190 | |
| Fat | 14 | g | 16 | g | 16 | g | 15 | g |
| Saturated Fat | 2 | g | 2 | g | 3 | g | 2.5 | g |
| +Trans Fat | 0 | g | 0 | g | 0 | g | 0 | g |
| Polyunsaturated | 6 | g | 6 | g | 9 | g | 4.5 | g |
| Fat | | | | | | | | |
| Omega 3³ | 0.8 | g | na | | 1.0 | g | 0.025 | g |
| Omega 6 | 5.2 | g | na | | 7.0 | g | 4.5 | g |
| Monounsaturated | 6 | g | 8 | g | 4 | g | 8 | g |
| Fat | | | | | | | | |
| Cholesterol | 0 | mg | 0 | mg | 0 | mg | 0 | mg |
| Sodium | 68 | mg | 120 | mg | 120 | mg | 140 | mg |
| Potassium³ | 318 | mg | n/a | | 240 | mg | 208 | mg |
| Carbohydrate | 11 | g | 7 | g | 8 | g | 8 | g |
| Fibre ² | 5 | g | 4 | g | 2 | g | 2 | g |
| Sugar | 2 | g | 3 | g | 4 | g | 3 | g |
| Protein | 4 | g | 7 | g | 8 | g | 7 | g |

| Vitamin C | 0% | | 0% | 0% | | 0% | |
|---|---|---|---|---|---|---|---|
| Calcium | 0% | | 2% | 2% | | 0% | |
| Vitamin A | 0% | | 0% | 0% | | 0% | |
| Iron³ | 11% | | 8% | 6% | | 4% | |
| Folic Acid³ | 13% | | 18% | 9% | | 0% | |
| Thiamine¹ | 30% | | 6% | 5% | | 0% | |
| Vitamin E³ | 13% | | Na | na | | 10% | |
| Selenium¹ | 45% | | na | 5% | | 3% | |
| Chromium³ | 8% | | na | na | | na | |
| Vitamin B6 ² | 15% | | 12% | 2% | | 9% | |
| Riboflavin³ | 7% | | 6% | 7% | | 2% | |
| Niacin³ | 6% | | 10% | 1% | | 20% | |
| Pantothenate³ | 6% | | 22% | 1% | | 3% | |
| Magnesium¹ | 55% | | 25% | 10% | | 12% | |
| Phosphorous¹ | 35% | | 24% | 11% | | 11% | |
| Biotin ² | 16% | | na | na | | na | |
| Zinc¹ | 26% | | 10% | 5% | | 6% | |
| Copper³ | 6% | | 25% | 9% | | 8% | |
| Manganese¹ | 29% | | 34% | 19% | | 23% | |
| Choline | 30 | mg | na | na | | 20.2% | |
| Lutein/Zeaxanthin | 158 | mcg | na | na | | na | |
| Phytosterols | 106 | mg | na | 5.4 | mg | 33 | mg |

¹Denotes nutrients for which NutraButter ™ composition is an excellent source and can be claimed as such under labeling requirements in Canada.
² Denotes nutrients for which NutraButter ™ composition is a good source and can be claimed as such under labeling requirements in Canada.
³Denotes nutrients for which NutraButter ™ composition can be claimed as a “source” under labeling requirements in Canada.

The corn germ butter, referenced herein as NutraButter™ composition” as used for the analysis in Table 5 comprises the following ingredients: toasted corn germ (VitaGerm™ mix, GreenField Naturals, Brampton, Canada), canola oil, sugar, mono-glycerides, di-glycerides, and salt. Note that artificial Vitamin E was added to the formulation.

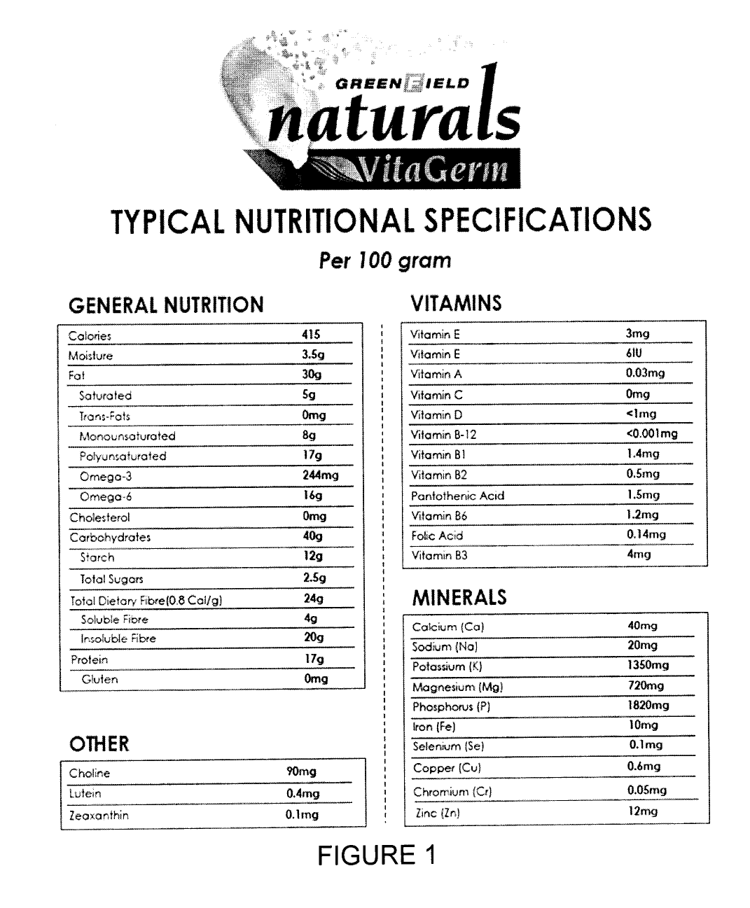

FIG. 1 shows an exemplary listing of the nutritional specifications for a proposed product called “VitaGerm™ mix” in a manner that would be displayed on a product label. The specifications are shown per 100 g of the corn germ product itself, which is in a form that may be used in production of a spreadable or flowable composition. Such a label can illustrate to the discerning consumer the high values of potassium, magnesium, fibre, and other such nutrients for comparison purposes.

### Example 2

NutraButter PLUS™ Composition

Using corn germ butter, for example the composition described above in Example 1, as a base, a healthy allergen-free spread is formed, as a peanut butter alternative. The composition is a healthy food product, and contains only naturally derived ingredients so as to provide nutrients in a form that is optimal for absorption, particularly with respect to vitamin and mineral absorption. While the composition can be viewed simply as a food, it can also be considered a naturally derived vitamin/mineral “supplement”.

The composition is formed as described above in Example 1, but includes some different ingredients. Isolated and toasted corn germ is combined with camelina oil, organic cane sugar, VitaBran™ mix—Corn Bran, Aquamin™ mix—Calcium (a natural source calcium mixture), Nutriflora™ mix—Fibre (a fibre product derived from natural source), and GrandFusion™ mix—Vitamins (a natural source vitamin/mineral nutrient supplement).

Optionally, naturally derived omega-3 fatty acids, such as from natural source algae, may be added to the composition. Such sources may be known to the discerning consumer of health food products, as a component to provide brain and heart healthy eicosapentaenoic acid (EPA) and docosahexaenoic acid (DHA). Such a composition containing natural source algae may be prepared with or without camelina oil as a fat source.

Additional vitamin source comes from the NutriFusion ™ mix micronutrient supplement product called GrandFusion™ mix. GrandFusion™ mix can be obtained from NutriFusion ™ of Hilton Head, S.C., USA, having a website address of www.nutrifusion.com.

NutriFusion ™ produces GrandFusion ™ mix, a product using a unique scientific process that promotes preservation of all-natural nutrients when added to foods and beverages. The GrandFusion™ product is believed to supercharge the nutritional value of food compositions to which it is added.

GrandFusion ™ allows food manufacturers to add natural nutrients from whole fruits and vegetables into food products. Food manufacturers can enhance the nutritional profile of a wide variety of food products, such as breads, muffins, cookies, energy bars, salad dressings, soups, yogurts and beverages using such supplementation. NutriFusion ™ mix can be baked, frozen, refrigerated, and added to liquids, drinks and beverages.

By utilizing the various GrandFusion ™ FruitNegetable products the content of natural source vitamins can be increased in the corn germ-based composition. This is particularly advantageous for children who may not otherwise achieve healthy choices for other meals or snacks.

Additional calcium and minerals in the example described herein may come from a naturally derived product called Aquamin™. The website of the product is found at www.aquamin.org (Marigot Ltd. Cork, Ireland). Aquamin™ is a naturally-derived, multi-mineral ingredient sourced from waters of the Irish and Icelandic coasts, which is believed to be particularly clear of contaminants. Aquamin™ contains calcium and other elements believed to be linked to improve bone and joint health. Aquamin™ enables the manufacturer to create a delicious food or beverage having an added nutritional benefit, without compromising on taste.

Intestinal health from the addition of the VitaBran™ corn bran may be improved as a result of the presence of insoluble fibre in the source. Insoluble fibres help maintain bowel health because as fibre passes through the small intestine and colon, it acts as roughage to slough mature cells from the tips of the villi with which the passing fibre has contact. A high-fibre diet may lower a consumer's risk of developing hemorrhoids and small pouches in the colon (diverticular disease). Some fibre is fermented in the colon by resident colonic bacteria, primarily the soluble fibre sources. The fermentation products, short-chain fatty acids, generally acetic, propionic and butyric acids, may have health benefits. Researchers are looking at how colonic fermentation may play a role in preventing diseases of the colon. Fibre has some correlation to reduced incidence of colon cancer, and it combats constipation. Soluble fibre, in particular, provides the undisputed advantage of softening and expanding stool volume, speeding up fecal transit and aiding in elimination.

Commercial preparations such as agar (Agarol™) and psyllium (Metamucil™) are effective stool bulkers, but are typically sold separately from foods.

Soluble fibre, for example from legumes, barley, oats, some fruit and vegetables, can help regulate blood sugar and has been correlated to reductions in serum cholesterol, which is deemed to be protective against heart disease.

Blood lipid composition has been shown to be reduced in a diet high in soluble fibres such as pectin, bean and oat gums, and fibre-containing legumes (lentils, chickpeas, navy, pinto or kidney beans).

Heart health can be improved with increased dietary fibre consumption. The addition of the corn-germ based product provides fibre and displaces less nutritious foods. Thus, its inclusion in the diet can provide cholesterol lowering effects.

Fibre consumption is also known to have a possible protective effect against cancer, and in particular colon cancer. Because bacteria resident in the colon converts soluble fibre into energy and short chain fatty acids, the process or products of this fermentation may be one mechanism by which fibre is protective against cancer.

Intestinal and immune system health may benefit from the addition of the fibre NutraFlora®. The product is available from Ingredion of Mississauga, Canada, having the website http://www.foodinnovation.com/gtcnutrition/Products/Pages/NUTRAFLORA.aspx.

NutraFlora™ is a prebiotic fibre derived from pure sugar cane utilizing a bio-fermentation proprietary process and non-GMO ingredients. It is a fermentable fibre, favoring certain beneficial bacteria (Bifidobacteria and Lactobacilli strains).

Additional omega-3 fatty acids are derived from the addition of camelina oil. A suitable source of camelina oil can be obtained from Three Farmers, of Saskatchewan, Canada, having a website at http://threefarmers.ca. Exemplary oils may be ones that are cold pressed. The camelina oil source is an artisanal source, with a naturally nutty flavour derived from the camelina seed. The source has an abundance of omega-3 and omega-6 fatty acids, as well as vitamin E. The oil is shelf-stable. Camelina oil, as a source omega-3 fatty acids may assist the consumer of the product in reduce the risk of coronary heart disease, and lower blood pressure levels.

A high level of vitamin E, having antioxidant properties, is also an advantage of the use of camelina oil in the composition. Omega Maiden™ is the name of a camelina oil source. This oil shows good stability and versatility compared with other vegetable oils.

The ratio of omega-6:omega-3 fatty acids in camelina oil is an advantage of using this oil source in the product. Camelina oil contains more than twice as many omega-3 fatty acids as omega-6 fatty acids.

The discerning consumer who selects a health food based on possible health benefits may recognize that brain development, joint health, and other benefits may derive from the presence of EPA and DHA in camelina oil.

In embodiments containing microalgae, DHA and EPA may be present in high quantities. DHA has been shown to be important for healthy brain and eye development and function, and has been shown to support heart health from infancy through adulthood. DHA serves an important role in brain and eye health. Both the American Heart Association and the USDA Dietary Guidelines recommend DHA for good cardiovascular health. And the National Institute of Health (NIH) recommends a minimum daily intake of 220 mg of DHA for healthy adults. EPA (eicosapentaenoic acid) is a long-chain polyunsaturated omega-3 fatty acid, and similarly has been associated with health benefits.

NutraButter PIus™ Composition

The composition is formulated to include ingredients which are known to have roles in health, such as described above.

The base material, including VitaGerm™ mix, as well as other aspects are as described above in Example 1.

In this example, NutraButter Plus™ composition contains NutraFlora™ mix, a prebiotic fructo-oligosaccharide with benefit to the colon, as described above.

NutraButter Plus™ composition also contains Aquamin™, mix, a calcified sea mineral rich in calcium, magnesium and 70 other trace minerals, including boron. The combination of this marine-derived calcium-rich multi-mineral supplement with Nutraflora™ mix (a short-chain fructo-oligosaccharide) may help maintain bone health.

NutraButter Plus™ composition is very high in magnesium which also has a role in developing and maintaining healthy bones.

NutraButter Plus™ composition contains GrandFusion ™ mix with multiple anti-inflammatory vitamins naturally derived from fruits and vegetables.

NutraButter Plus™ composition is rich in Omega 3 ALA from cold pressed camelina oil, which includes omega-3 fatty acids which have anti-inflammatory and other beneficial properties.

Similar to the Example 1 composition, NutraButter Plus™ composition is low in saturated fat and is trans fat and cholesterol free, and is formulated to be dairy free.

NutraButter Plus™ composition contains naturally occurring lutein and zeaxanthin, nutrients associated with eye health, as well as naturally occurring choline, a nutrient linked to brain health.

NutraButter Plus™ composition is made from isolated corn germ that has been toasted. The germ is then pulverized or mixed, and the additional products listed herein are added either during or after pulverization and/or mixing, including such exemplary products as NutraFlora™ mix, Aquamin™ mix, and GrandFusion™ mix.

The product may be utilized by a consumer wishing to access an all natural food containing high levels of ingredients which may be implicated in improved health, for example as non-drug therapy, or for improving joint health.

Full compositional content and comparison of the composition to commercially available sunflower butter, soy butter and peanut butter is provided in Table 6. This table shows relatively similar calorie and macronutrient content (carbohydrate, fat, and protein), but also demonstrates that higher content of certain nutrients such as vitamins and minerals are derived from the corn germ product, leading to a more nutritious composition than the comparable spreads.

TABLE 6
NutraButter Plus ™ Composition: Nutritional
Comparisons With other Proteinaceous Spreads

| | NutraButter | | | | | | | |
|---|---|---|---|---|---|---|---|---|
| Component per | Plus ™ | | Sunflower | | Soy | | Peanut | |
| 32 g (2 tbsp) | Composition | | Butter | | Butter | | Butter | |
| Calories | 170 | | 200 | | 200 | | 190 | |
| Fat | 13 | g | 16 | g | 16 | g | 15 | g |
| Saturated Fat | 2.5 | g | 2 | g | 3 | g | 2.5 | g |
| +Trans Fat | 0 | g | 0 | g | 0 | g | 0 | g |
| Polyunsaturated | 7 | g | 6 | g | 9 | g | 4.5 | g |
| Fat | | | | | | | | |
| Omega 3³ | 2.2 | g | na | | 1.0 | g | .025 | g |
| Omega 6 | 4.8 | g | na | | 7.0 | g | 4.5 | g |
| Monounsaturated | 3.5 | g | 8 | g | 4 | g | 8 | g |
| Fat | | | | | | | | |
| Cholesterol | 0 | mg | 0 | mg | 0 | mg | 0 | mg |
| Sodium | 65 | mg | 120 | mg | 120 | mg | 140 | mg |
| Potassium³ | 270 | mg | na | | 240 | mg | 208 | mg |
| Carbohydrate | 11 | g | 7 | g | 8 | g | 8 | g |
| Fibre¹ | 7 | g | 4 | g | 2 | g | 2 | g |
| Sugar | 1 | g | 3 | g | 4 | g | 3 | g |
| Protein | 3 | g | 7 | g | 8 | g | 7 | g |

| Vitamin A¹ | 25% | | 0% | 0% | | 0% | |
|---|---|---|---|---|---|---|---|
| Vitamin C¹ | 25% | | 0% | 0% | | 0% | |
| Calcium¹ | 25% | | 2% | 2% | | <2% | |
| Iron | 12% | | 8% | 6% | | 4% | |
| Folic Acid³ | 10% | | 18% | 9% | | na | |
| Thiamine¹ | 50% | | 6% | 5% | | na | |
| Vitamin E³ | 13% | | na | na | | 10% | |
| Selenium¹ | 35% | | na | 5% | | 3% | |
| Chromium³ | 6% | | na | na | | na | |
| Vitamin B6¹ | 25% | | 12% | 2% | | 9% | |
| Riboflavin³ | 10% | | 6% | 7% | | 2% | |
| Niacin³ | 10% | | 10% | 1% | | 20% | |
| Pantothenate³ | 10% | | 22% | 1% | | 3% | |
| Magnesium¹ | 60% | | 25% | 10% | | 12% | |
| Phosphorous¹ | 25% | | 24% | 11% | | 11% | |
| Biotin² | 15% | | na | na | | na | |
| Zinc² | 15% | | 10% | 5% | | 6% | |
| Copper³ | 6% | | 25% | 9% | | 8% | |
| Manganese² | 20% | | 34% | 19% | | 23% | |
| Choline | 24 | mg | na | na | | 20.2% | |
| Lutein/Zeaxanthin | 130 | mcg | na | na | | na | |
| Phytosterols | 86 | mg | na | 5.4 | mg | 33 | mg |

¹Denotes nutrients for which NutraButter Plus ™ composition is an excellent source and can be claimed as such under labeling requirements in Canada.
²Denotes nutrients for which NutraButter Plus ™ composition is a good source and can be claimed as such under labeling requirements in Canada.
³Denotes nutrients for which NutraButter Plus ™ composition can be claimed as a “source” under labeling requirements in Canada.

The corn germ butter, referenced herein as “NutraButter Plus™ composition: as used for the analysis in Table 6 comprises the following ingredients: Toasted corn germ, cold pressed camelina oil, sugar, corn bran, NutraFlora™ mix, calcified sea mineral powder, mono- and di-glycerides.

Optional ingredients may include dehydrated whole food concentrates of apple, orange, tomato, cranberry, broccoli, carrot and shiake mushrooms, and salt. The following compositions in subsequent examples each contains NutraButter Plus™ composition, and is formulated in a slightly different manner to permit a variety of choices to the consumer.

### Example 3

NutraButter Plus™ Composition—Basic Formula

The following ingredients shown in Table 7 are combined in the amounts shown to formulate a composition consistent with the details provided in Example 2.

TABLE 7
NutraButter Plus ™ Composition - Basic Formula

| Inaredient | Content (wt/wt %) |
|---|---|
| Toasted Corn Germ Moisture <6% | 54% |
| Camelina Oil | 25% |
| Sugar | 6.5% |
| Corn Bran | 7.0% |
| Mono-glyceride | 2.75% |
| Aquamin ™ Mix | 1.80% |
| GrandFusion ™ Mix − Vegetable + Fruit | 0.35% |
| NutraFlora ™ Mix | 2.5% |
| Salt | 0.51% |

### Example 4

NutraButter Plus™ Composition—EPA/DHA & Camelina Formula

The following ingredients shown in Table 8 are combined in the amounts shown to formulate a composition consistent with the details provided in Example 2.

TABLE 8
NutraButter Plus ™ Composition -
EPA/DHA & Camelina Formula

| Ingredient | Content (wt/wt %) |
|---|---|
| Toasted Corn Germ Moisture <6% | 54% |
| Camelina Oil | 22% |
| Sugar | 6.5% |
| Corn Bran | 7.0% |
| Mono-glyceride | 2.75% |
| Aquamin ™ Mix | 1.80% |
| GrandFusion ™ Mix − Vegetable + Fruit | 0.35% |
| NutraFlora ™ Mix | 2.5% |
| EPA/DHA Algae Source | 3.0% |
| Salt | 0.51%. |

### Example 5

NutraButter Plus™ Composition—EPA/DHA & Canola/Camelina Formula

The following ingredients shown in Table 9 are combined in the amounts shown to formulate a composition consistent with the details provided in Example 2.

TABLE 9
NutraButter Plus ™ Composition -
EPA/DHA & Canola/Camelina Formula

| Ingredient | Content (wt/wt %) |
|---|---|
| Toasted Corn Germ Moisture <6% | 54% |
| Canola Oil/Camelina | 22% |
| Sugar | 6.5% |
| Corn Bran | 7.0% |
| Mono-glyceride | 2.75% |
| Aquamin ™ Mix | 1.80% |
| GrandFusion ™ Mix - Vegetable + Fruit | 0.35% |
| NutraFlora ™ Mix | 2.5% |
| EPA/DHA Algae Source | 3.0% |
| Salt | 0.51% |

### Example 6

NutraButter PIus™ Composition—Canola/Camelina Formula

The following ingredients shown in Table 10 are combined in the amounts shown to formulate a composition consistent with the details provided in Example 2.

TABLE 10
NutraButter Plus ™ Composition - Canola/Camelina Formula

| Ingredient | Content (wt/wt %) |
|---|---|
| Toasted Corn Germ Moisture | 54% |
| Canola Oil/Camelina Oil Blend | 25% |
| Sugar | 6.5% |
| Corn Bran | 7.0% |
| Mono-glyceride | 2.75% |
| Aquamin ™ Mix | 1.80% |
| GrandFusion ™ Mix - Vegetable + Fruit | 0.35% |
| NutraFlora ™ Mix | 2.5% |
| Salt | 0.51% |

### Example 7

Corn Germ Spread—NutraButter Ultra™ Composition-A

The corn germ spreads in this Example are formulated with corn germ purchased in Canada from Bunge Limited (general contact office: White Plains, N.Y.). Prior to toasting and pulverization of the corn germ, the germ utilized in this example is supplied in a form that comprises broken germ particles. Ingredients are shown in Table 11 to Table 16.

The corn germ spreads and are combined in the manner described above for previous examples. The oil used in the spreads of this Example may be any acceptable edible oil or a combination of two or more edible oils, such as palm fruit oil, canola oil, corn oil, camelina oil, and combinations of these. When oils having certain desirable properties are used (alone or in mixtures), such as palm fruit oil used alone or in combination with canola oil, then the mono-glyceride component may be omitted.

When supplemented with vitamin and/or mineral supplements, the spread may utilize different sources, depending on such parameters as price, availability, and/or the consumer target group. The source of mineral and/or vitamin supplement used in the formulations of this Example may be any source acceptable to Health Canada for use in food products, and may be tailored toward consumer acceptance. A sea-derived mineral source may be used, such as Aquamin™ mix. A natural source of vitamins may be used, such as GrandFusion™ mix, which is derived from fruits and vegetables.

TABLE 11
NutraButter Ultra ™ Composition-A

| Ingredient | Content (wt/wt %) |
|---|---|
| Toasted Corn Germ | 40% |
| Sugar | 8.00% |
| Canola Oil | 40.00% |
| Mono Glyceride | 2.75% |
| Corn Bran | 3.00% |
| GrandFusion ™ mix | 0.14% |
| Vitamin Supplement (ie - Aquamin ™ mix) | 1.80% |
| Starch/Maltodextrin | 3.31% |
| Salt | 1.00% |

TABLE 12
NutraButter Ultra ™ Composition-B

| Ingredient | Content (wt/wt %) |
|---|---|
| Toasted Corn Germ | 40.00% |
| Sugar | 8.00% |
| Canola Oil | 40.00% |
| Mono Glyceride | 2.75% |
| Corn Bran | 3.00% |
| GrandFusion ™ mix | 0.35% |
| Vitamin Supplement (ie - Aquamin ™ mix) | 1.80% |
| Starch/Maltodextrin | 3.31% |
| Salt | 1.00% |

TABLE 13
NutraButter ™ Composition-C

| Ingredient | Content (wt/wt %) |
|---|---|
| Toasted Corn Germ | 40.00% |
| Sugar | 8.00% |
| Oil | 40.00% |
| Mono Glyceride | 2.60% |
| Starch/Maltodextrin | 8.40% |
| Salt | 1.00% |

TABLE 14
NutraButter Unsweetened ™ Composition-D

| Ingredient | Content (wt/wt %) |
|---|---|
| Toasted Corn Germ | 45.00% |
| Sugar | 0.00% |
| Oil | 45.00% |
| Mono Glyceride | 3.40% |
| Starch/Maltodextrin | 5.60% |
| Salt | 1.00% |

TABLE 15
NutraButter Chocolate ™ Composition-E

| Ingredient | Content (wt/wt %) |
|---|---|
| Toasted Corn Germ | 27.20% |
| Sugar | 29.00% |
| Oil | 27.20% |
| Mono Glyceride | 2.00% |
| Corn Bran | 3.00% |
| Cocao | 10.00% |
| Starch/Maltodextrin | 1.00% |
| Salt | 0.60% |

TABLE 16
Supplemented NutraButter Ultra Chocolate ™ Composition-F

| Ingredient | Content (wt/wt %) |
|---|---|
| Toasted Corn Germ | 26.50% |
| Sugar | 28.46% |
| Oil | 26.50% |
| Mono Glyceride | 2.00% |
| Corn Bran | 3.00% |
| GrandFusion ™ mix | 0.14% |
| Vitamin Supplement (ie - Aquamin ™ Mix) | 1.80% |
| Cocao | 10.00% |
| Starch/Maltodextrin | 1.00% |
| Salt | 0.60% |

### Example 8

Chocolate Corn Germ Spread

The corn germ spreads in this Example are formulated with corn germ purchased in Canada from Bunge Limited (general contact office: White Plains, N.Y.). Prior to toasting and pulverization of the corn germ, the germ utilized in this example is supplied in a form that comprises broken germ particles. Each of the spreads contains cocao, and is formulated to appeal to the consumer who is interested in a spread having chocolate character and flavor.

Ingredients are shown in Table 17 to Table 19. Oil and mono-glyceride selection may proceed as described above in Example 7.

The corn germ spreads and are combined in the manner described above for previous examples. When supplemented with vitamin and/or mineral supplements, the spread may utilize different sources, depending on such parameters as price, availability, and/or the consumer target group. The source of mineral and/or vitamin supplement used in the formulations of this Example may be any source acceptable to Health Canada for use in food products, and may be tailored toward consumer acceptance. A sea-derived mineral source may be used, such as Aquamin™ mix. A natural source of vitamins may be used, such as GrandFusion™ mix.

TABLE 17
Chocolate NutraButter ™ Composition-A

| Ingredient | Content (wt/wt %) |
|---|---|
| Toasted Corn Germ | 29.54% |
| Sugar | 29.00% |
| Oil | 29.54% |
| Mono Glyceride | 1.50% |
| Vanilin | 0.015% |
| Cocao | 10.00% |
| Starch/Maltodextrin | 0.00% |
| Salt | 0.40% |

TABLE 18
Chocolate NutraButter Supplemented ™ Composition-B

| Ingredient | Content (wt/wt %) |
|---|---|
| Toasted Corn Germ | 30.00% |
| Sugar | 22.50% |
| Oil | 30.00% |
| Mono Glyceride | 1.60% |
| Corn Bran | 3.35% |
| GrandFusion ™ mix | 0.35% |
| Aquamin ™ mix | 1.80% |
| Cocao | 10.00% |
| Starch/Maltodextrin | 0.00% |
| Salt | 0.40% |
| Vanilin | 0.02% |

TABLE 19
Chocolate NutraButter Supplemented ™ Composition-C

| Ingredient | Content (wt/wt %) |
|---|---|
| Toasted Corn Germ | 26.49% |
| Sugar | 22.50% |
| Oil | 26.49% |
| Mono Glyceride | 1.10% |
| Corn Bran | 3.35% |
| GrandFusion ™ mix | 0.35% |
| Aquamin ™ mix | 1.80% |
| Rice Protein 80% | 7.50% |
| Cocao | 10.00% |
| Starch/Maltodextrin | 0.00% |
| Salt | 0.40% |
| Vanilin | 0.021% |

### Example 9

NutraButter Full Monty™ Composition

The corn germ spread in this Example is formulated with corn germ purchased in Canada from Bunge Limited (general contact office: White Plains, N.Y.). Prior to toasting and pulverization of the corn germ, the germ utilized in this example is supplied in a form that comprises broken germ particles. Table 20 provides the complete details of the composition. Note that certain components not present in the composition are provided in the list as having 0% content.

TABLE 20
NutraButter Full Monty ™ Composition

| Ingredient | Content (wt/wt %) |
|---|---|
| Toasted Corn Germ | 27.522% |
| Sugar | 23.850% |
| Oil | 27.522% |
| Mono Glyceride | 1.398% |
| Corn Bran | 0.000% |
| GrandFusion ™ 661 Mix | 10.000% |
| Aquamin ™ Mix | 0.000% |
| Cocao | 9.315% |
| Vanilin | 0.018% |
| Starch/Maltodextrin | 0.000% |
| Salt | 0.373% |

### Example 10

NutraButter Smooth™ Composition

The corn germ spread in this Example is formulated with corn germ purchased in Canada from Bunge Limited (general contact office: White Plains, N.Y.). Prior to toasting and pulverization of the corn germ, the germ utilized in this example is supplied in a form that comprises broken germ particles. Table 21 and Table 22 provide detailed ingredients lists for a composition that is smooth, with and without cocao.

TABLE 21
NutraButter Smooth ™ Composition

| Ingredient | Content (wt/wt %) |
|---|---|
| Toasted Corn Germ | 40.00% |
| Sugar | 8.00% |
| Oil | 40.00% |
| Mono Glyceride | 2.75% |
| Corn Bran | 3.10% |
| GrandFusion ™ Mix | 0.35% |
| Maltodextrin | 4.80% |
| Salt | 1.00% |

TABLE 22
NutraButter Ultra Chocolate ™ Composition-G

| Ingredient | Content (wt/wt %) |
|---|---|
| Toasted Corn Germ | 30.6% |
| Sugar | 26.5% |
| Oil | 30.6% |
| Mono Glyceride | 1.5% |
| GrandFusion ™ mix | 0.40% |
| Cocao | 10.00% |
| Salt | 0.40% |

The nutritional analysis of the above composition of Table 21 is provided below in Table 23, as it might appear on a label of a product, approved for sale in Canada. The ingredients, for example, as may be listed on a nutrition label, are as follows: INGREDIENTS Toasted corn germ, Canola oil, Sugar, Maltodextrin, Corn bran, Mono glyceride, Salt, Dehydrated whole food concentrates of Spinach, Broccoli, Carrot, Beet (Beta Vulgaris), Tomato, shiake Mushroom, Apple, Cranberry, Cherry, Orange, Blueberry and Strawberry. The dehydrated whole food concentrates may be derived from a mix, such as the GrandFusion™ mix of fruit and vegetable concentrates.

TABLE 23
NutraButter Smooth ™ Composition - Nutritional Analysis
NUTRITION FACTS Per 32 g (1 serving)

| Calories 200 | % Daily Value |
|---|---|
| Fat 17 g | 26% |
| Saturated Fat 2 g | 10% |
| + Trans Fat 0 g | 0% |
| Polyunsaturated Fat 6 g | |
| Omega 3 1.2 g | |
| Omega 6 4.8 g | |
| Monounsaturated Fat 9 g | |
| Cholesterol 0 mg | 0% |
| Sodium 130 mg | 5% |
| Potassium 160 mg | 6% |
| Carbohydrate 10 g | 3% |
| Fibre 4 g | 16% |
| Sugars 3 g | |
| Protein 3 g | 6% |
| Vitamin A | 25% |
| Vitamin C | 25% |
| Calcium | 0% |
| Iron | 6% |
| Vitamin E | 40% |
| Vitamin D | 30% |
| Folic Acid | 40% |
| Riboflavin | 35% |
| Thiamine | 42% |
| Pantothenate | 25% |
| Vitamin B6 | 35% |
| Biotin | 35% |
| Vitamin K | 25% |
| Selenium | 15% |
| Magnesium | 15% |
| Phosphorous | 15% |
| Zinc | 10% |
| Manganese | 15% |
| Chromium | 5% |
| Copper | 5% |

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

1. A food composition having a paste form, comprising pulverized corn germ and a fat source.

2. The composition of claim 1, wherein the corn germ is pulverized from an isolated corn germ source.

3. The composition of claim 2, wherein the isolated corn germ source is an intact corn germ that has not been exposed to or extracted with organic solvent.

4. The composition of claim 1, additionally comprising sugar, salt, mono-glyceride, di-glyceride, or a mixture thereof.

5. The composition of claim 1, wherein the total fat content of the composition is from 20 to 65% fat by weight.

6. (canceled)

7. (canceled)

8. The composition of claim 1, wherein the corn germ is pulverized to a particle size of from 0.1 mm to 4 mm (0.004 inch to 0.016 inch).

9. The composition of claim 1, additionally comprising a vitamin supplement, a mineral supplement, or a combined vitamin and mineral supplement.

10. (canceled)

11. (canceled)

12. The composition of claim 1, additionally comprising a dietary fibre or an indigestible edible component that is fermentable by colonic bacteria.

13. The composition of claim 1, wherein the fat source comprises a plant source oil high in omega-3 fatty acids.

14. (canceled)

15. (canceled)

16. The composition of claim 13, wherein the oil comprises canola oil or camelina oil.

17. The composition of claim 1, additionally comprising a flavor or color.

18. The composition of claim 17 wherein the color is added to change the composition to a color that is visually distinguishable from the color of peanut butter.

19. The composition of claim 1, additionally comprising cocoa.

20. (canceled)

21. (canceled)

22. (canceled)

23. (canceled)

24. (canceled)

25. (canceled)

26. (canceled)

27. A method of bestowing nutritional or health benefits to an individual comprising delivering to the individual for oral consumption a food composition having a paste form, comprising pulverized corn germ and a fat source.

28. (canceled)

29. The method of claim 27, wherein the individual has an allergy or is suspected of having an allergy to a priority allergen, or wherein the individual is immune-compromised, is a diabetic or pre-diabetic, has joint pain, has high cholesterol or blood lipids, or has cardiovascular disease.

30. (canceled)

31. A method of preparation of a food composition comprising:
obtaining pulverized corn germ from an isolated corn germ source; and
mixing the pulverized corn germ with a fat source to form a paste.

32. The method of claim 31, wherein prior to mixing, the corn germ is pulverized to a smooth consistency.

33. The method of claim 31, wherein the pulverized corn germ has a particle size of:
from 0.1 mm to 4.0 mm (0.004 inch to 0.016 inch);
from 0.12 mm to 2.0 mm (0.005 inch to 0.007 inch); or
about 1.5 mm (0.006 inch).

34. (canceled)

35. (canceled)

36. The method of claim 31 wherein corn germ source is not isolated by wet milling.

37. (canceled)

38. The method of claim 31, additionally comprising:
adding sugar, salt, mono-glyceride, di-glyceride, or a mixture thereof to the corn germ during or after mixing the corn germ with the fat source;
adding a vitamin supplement, a mineral supplement, or a combined vitamin and mineral supplement during or after mixing the corn germ with the fat source; and/or
adding a dietary fibre or an indigestible edible component that is fermentable by colonic bacteria during or after mixing the corn germ with the fat source.

39. (canceled)

40. (canceled)

41. The method of claim 31, wherein the fat source comprises a plant source oil high in omega-3 fatty acids.

42. The method claim 41, wherein the oil comprises canola oil or camelina oil.

43. (canceled)

44. (canceled)

45. The method of claim 31, additionally comprising adding a flavor or color during or after mixing the corn germ with the fat source.

46. The method of claim 45, wherein the color is added to change the composition to a color that is visually distinguishable from the color of peanut butter.

47. (canceled)

48. (canceled)

49. A confectionery or baked product comprising the composition according to claim 1.

50. (canceled)

51. (canceled)
